(19) United States
(12) Patent Application Publication
(10) Pub. No.: US 2026/0148576 A1
(43) Pub. Date: May 28, 2026

(54) AUTO-LABELING WITH DYNAMIC FILTERING

(71) Applicant: Walmart Apollo, LLC, Bentonville, AR (US)

(72) Inventors: Huanyu Zang, Frisco, TX (US); Wei Wang, Dallas, TX (US); Feiyun Zhu, Plano, TX (US); Yanmei Jin, Dallas, TX (US); Lingfeng Zhang, Flower Mound, TX (US); Mingquan Yuan, Flower Mound, TX (US); Zhaoliang Duan, Frisco, TX (US); William Craig Robinson, Centerton, AR (US); Colin Grant Mitchell, Wills Point, TX (US); Xin Ma, Arlington, TX (US)

(21) Appl. No.: 19/178,607

(22) Filed: Apr. 14, 2025

Related U.S. Application Data
(60) Provisional application No. 63/634,539, filed on Apr. 16, 2024.

(51) Int. Cl. G06V 20/70; G06V 10/764

(52) U.S. Cl. CPC G06V 20/70; G06V 10/764; G06V 2201/07

(57) ABSTRACT

Examples provide a system and method for dynamically filtering candidate item identifiers (IDs) from a pool of item IDs in real-time for automatic labeling of images for use as training data used to train computer vision (CV) models. Images of carts are paired with item receipts. Candidate item IDs are extracted from the receipts. Item recognition inference results generated by CV models are used to pair images of individual items with item IDs identifying the item in each item image. As each candidate item ID is assigned to an item image, the item ID is dynamically filtered. Any candidate item IDs remaining after filtering are assigned to any item images failing to pair with an item ID based on the infer results. The results are presented for review and status update via a user interface device for faster and more accurate auto-labeling of training data for CV models.

### BACKGROUND

Computer vision (CV) object detection models, such as image recognition as a service (IRAS) models, may be used for automated item detection and identification of items in images. These models are typically trained using manually labeled training data. The training data frequently consists of images with labeled objects in the images. Humans label the images manually to create the training data. This is an expensive, inefficient, and a time-consuming process.

### SUMMARY

Some examples provide dynamic filtering and selective item-to-image pairing for accurate auto-labeling image data. The system identifies candidate item identifiers (IDs) associated with a plurality of items in a receipt associated with a selected transaction in a retail facility. A plurality of item images are obtained from the source image corresponding to the receipt. Each item image in the plurality of item images include an image of a single item cropped from the source image. A set of item images is paired with a set of matching item IDs based on item infer results. Each item image is paired with a single item ID from the set of candidate item IDs. Paired item IDs are filtered from the set of candidate item IDs. The remaining item IDs are paired with any remaining item images that remain unpaired to an item ID. Receipt sampling is employed, and those receipts corresponding to item IDs (UPCs) with fewer templates have a higher chance of being sampled, in order to minimize redundancy. The item image-to-item ID pairs are presented to a user via a user interface (UI) device for verification and correction of any auto-labeling errors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for automatic labeling of images with dynamic filtering.

FIG. 2 is an exemplary block diagram illustrating a retail facility including image capture devices and checkout terminals for generating receipts and cart images.

FIG. 3 is an exemplary block diagram illustrating a label manager for automatically labeling images with dynamic filtering.

FIG. 4 is an exemplary block diagram illustrating pairing of item identifiers (IDs) with item images using dynamic filtering.

FIG. 5 is an exemplary block diagram illustrating status update of labeled images via a results user interface (UI) page.

FIG. 6 is an exemplary flow diagram illustrating operation of the computing device to apply dynamic filtering during automatic labeling of item images.

FIG. 7 an exemplary flow chart illustrating operation of the computing device to generate labeled item images at a single transaction level for use in training data.

FIG. 8 is an exemplary flow chart illustrating operation of the computing device to filtering paired item IDs from a pool of candidate item IDs during automatic labeling of item images.

FIG. 9 an exemplary flow chart illustrating operation of the computing device to verify labeled image data with feedback obtained via a UI at a single transaction level.

FIG. 10 is an exemplary table illustrating item data used during pairing of item images with item IDs.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . .” For brevity and clarity of presentation, this implied leading clause is not repeated ad nauseum.

There are frequently a large number of transactions that occur every single day in stores and other retail facilities. Customer shopping carts frequently contain large numbers of items at checkout time. Cart images captured by cameras at or near the checkout areas provide item images that are a good resource for training computer vision (CV) item detection and recognition models used to detect objects of interest in images captured by one or more cameras. A CV model's performance can directly depend on the number of labeled images and quality of labeled images available for training the CV model. In other words, accurately labeled images are needed to train CV models to accurately detect and recognize objects of interest. However, manual labeling is expensive and time-consuming work.

Referring to the figures, examples of the disclosure enable a pipeline for generating labeled image data using dynamic filtering and a results review user interface (UI) page. In some examples, sample transactions are performed before pairing. Those receipts containing item IDs of interest, such as universal product codes (UPCs), are sampled instead of all daily transaction receipts, to reduce the number of item images and further reduce the manual labeling efforts. The system filters paired item IDs from a pool of candidate IDs as the item IDs are being paired with item images. This reduces the number of remaining item IDs in the pool of candidate item IDs which are available to match to item images during image labeling. This feature further minimizes human time and effort expended during manual labeling of images by reducing the number of possible candidate IDs to pair with each image, as well as improves the accuracy of item image labeling by limiting the possible combinations of item images and item IDs which can be matched together.

Aspects of the disclosure further enable filtering candidate item IDs in real time during automatic labeling to reduce erroneous pairing of item IDs with item images while increasing the speed and efficiency with which each item image is matched to a correct item ID label.

Other embodiments enable matching each unpaired item image in the plurality of item images with each item ID in the set of remaining item IDs. Each item image in the set of remaining item images is paired with multiple item IDs to form a set of multi-labeled item images. This reduces the number of possible item image-to-candidate item ID pairings. The reduced number of combinations reduces system resource usage, such as system memory, processor usage and network bandwidth usage consumed during automatic labeling.

The computing device operates in an unconventional manner by filtering candidate item IDs in real-time and presenting paired image-to-item ID results to users for review and manual verification of image labeling via a review UI page. In this manner, the computing device is used in an unconventional way, and allows improved the accuracy of automatic item image labeling while reducing system memory, processor and network bandwidth usage which would otherwise be expended during extensive manual labeling and correction of automatic labeling errors, thereby improving the functioning of the underlying computing device.

Other embodiments present automatically labeled image data, including item IDs paired with item images, for manual review, status update, and/or re-labeling. This enables improved user efficiency via UI interaction and increased user interaction performance.

Auto-labeling provides a fast approach to select and match item images for items recorded in a receipt as universal product codes (UPCs) or other item IDs. By leveraging the inferred results generated by CV models, the system reduces manual time expended by human users on labeling images for use as training data. The unique selection algorithm filters negative (incorrectly labeled) item images more accurately for reduced errors during the auto-labeling process. A combination of auto-labeling and manual review deliver improved performance while reducing overall system resource usage expended during labeling of image data.

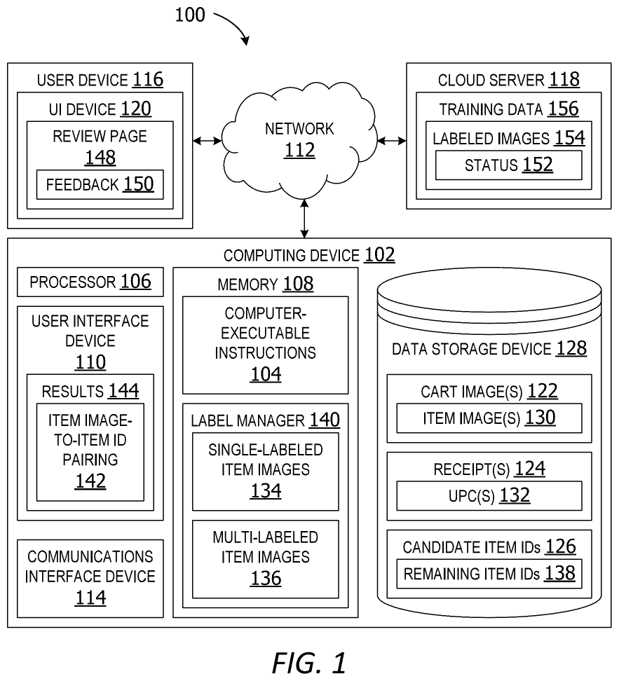

Referring again to FIG. 1, an exemplary block diagram illustrates a system 100 for automatic labeling of images with dynamic filtering. Image labels may also be referred to as annotated images or annotated image data. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

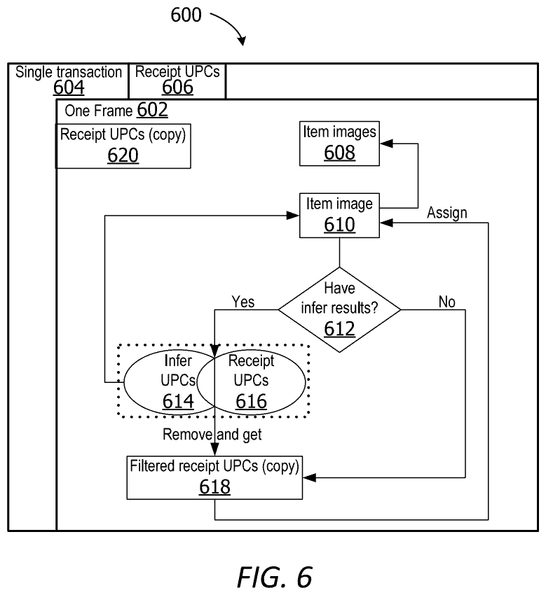

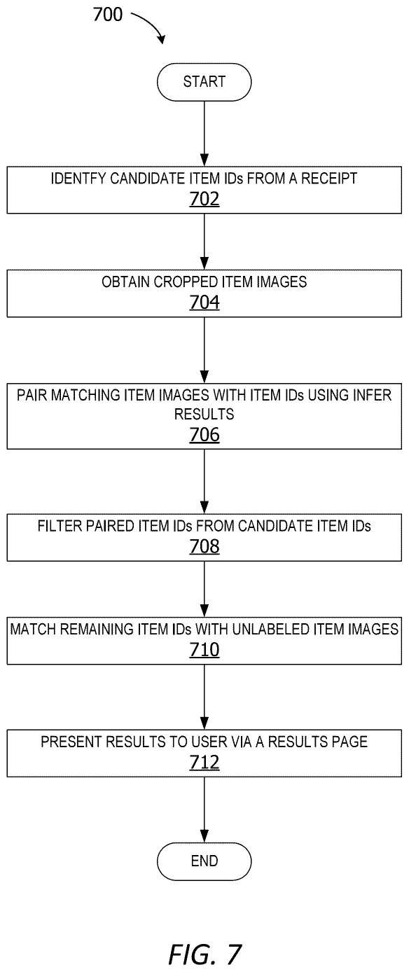

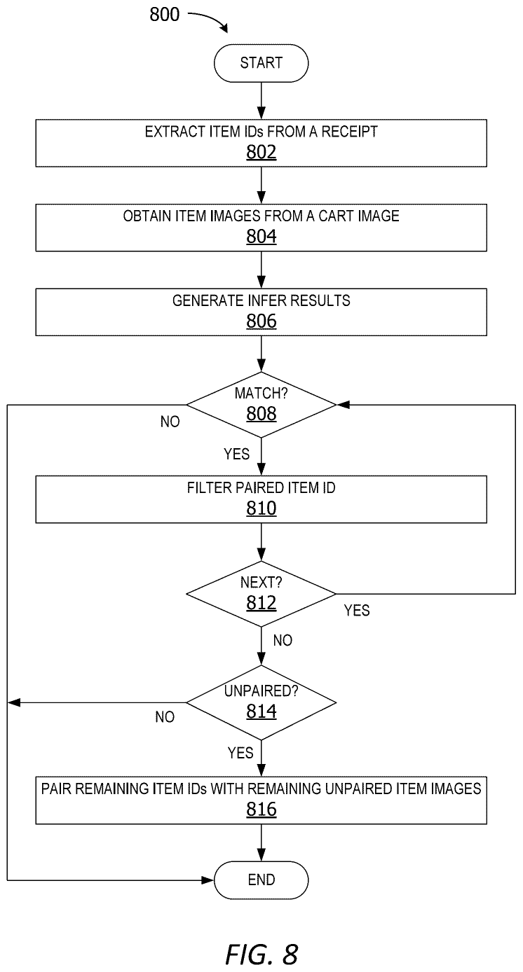

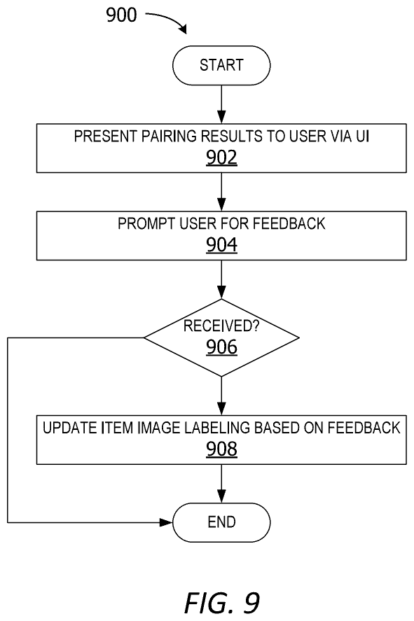

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 6, FIG. 7, FIG. 8, and FIG. 9).

The computing device 102 further has one or more computer-readable media, such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 128 for storing data, such as, but not limited to one or more cart image(s) 122, one or more receipt(s) 124, the set of candidate item IDs 126 and/or item inference (infer) results 144. The cart image(s) 122 includes one or more images of a customer shopping cart associated with one or more receipt(s) 124. Each cart image includes an image of one or more items purchased by the customer. The item ID for each purchased item is recorded on a receipt corresponding to a source image, such as an image of a shopping cart. An item ID is an identifier associated with an item. An item ID includes for example, but without limitation, a universal product code (UPC), item serial number, or any other type of item ID. Each receipt includes one or more UPC(s) 132 associated with one or more items purchased during a transaction corresponding to the receipt.

The set of candidate item IDs 126 includes one or more item IDs extracted from a receipt. A candidate item ID is an ID for an item which is likely to appear in a cart image corresponding to the receipt from which the candidate item ID is extracted.

The results 144 are generated by a CV model, such as an item detection model, an item recognition model, a classification model, and/or a verification model. The results 144 include an item ID and a probability that an item in an item image is an item represented by the item ID. For example, item infer results for an item image of a bag of limes includes a predicted item ID for a product that is described as a bag of limes product and a probability value indicating the likelihood that the item ID for the bag of limes correctly identifies the item image of the bag of limes.

The item image(s) 130 include one or more images of each individual item detected in a selected cart image from the one or more cart image(s) 122. Each item image in the set of item image(s) 130 includes an image of a single item cropped or removed from a cart image. In other words, the image of an item visible in the source image of the shopping cart is obtained from the source image by discarding or cropping off images of other objects which are not of interest in order to isolate the object of interest shown in the source image. In some embodiments, the item image(s) 130 are generated by a trained CV object detection model.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 128 includes a database.

The data storage device 128 in this example is included within the computing device 102, attached to the computing device, plugged into the computing device, or otherwise associated with the computing device 102. In other examples, the data storage device 128 includes a remote data storage accessed by the computing device via the network 112, such as a remote data storage device, a data storage in a remote data center, or a cloud storage.

The memory 108 in some embodiments stores one or more computer-executable components. The label manager component, when executed by the processor 106 of the computing device 102, extracts the set of candidate item IDs 126 associated with a plurality of items from a receipt in the set of receipt(s) 124. The label manager 140 obtains a plurality of item image(s) 130 from a cart image in the set of cart image(s) 122 associated with the receipt. In some examples, the item images are generated by a CV object (item) detection model. Each item image in the plurality of item images includes an image of a single item cropped from the cart image.

In some embodiments, the label manager 140 pairs or matches a set of one or more of the item images with a set of one or more matching candidate item IDs. Each item image is paired with one or more item IDs from the set of candidate item IDs using item recognition results obtained from an item recognition model to form a set of single-labeled item images. If a candidate item ID is predicted to be the only correct match for a given item image, that candidate item ID is paired with the matching item image and then filtered from the set of candidate item IDs 126. These single labeled item images 134 include item images having only a single paired item ID that is predicted to be the correct label for the item image. Multi-labeled item images 136 include item images for which a single item ID is not predicted to most likely be the correct label for the item image. In this case, the item image is matched with any remaining item IDs 138 in the which have not been filtered from the set of candidate item IDs 126. The set of candidate item IDs 126 can also be referred to as a pool of candidate item IDs.

The results 144 of the item image-to-item ID pairing 142 are presented to a user via a UI device, such as, but not limited to, the user interface device 110 and/or the UI device 120 of the user device 116. In some embodiments, the results 144 are displayed to the user in a review page 148. The review page 148 presents the item images with one or more paired item IDs for review by the user, status update, and/or relabeling where the generated label is incorrect.

The user provides feedback 150 indicating that the paired item ID for each item image is correct (verified) or incorrect. If the item ID paired with the image is incorrect, the user can optionally re-label the image or otherwise correct the labeling.

In other examples, the user can update the status 152 of each item image presented via the review page 148. The status 152 includes a correct status, an incorrect status and/or a new (unlabeled) status for item images which have not yet received a label. The correctly labeled images 154 are added to training data 156 which is used to train or retrain CV models, such as CV object detection models and/or CV object recognition models trained using labeled image data.

In these embodiments, an image, such as the cart image(s) 122 and/or the item image(s) 130, do not include images of users or other individuals within the retail facility. A cart image may be referred to as a source image from which a plurality of images of items are cropped. Any images having human users or other objects which are not of interest inadvertently included within the images are removed from the image(s) by cropping the images such that only objects of interest remain in the stored images. Images of users or objects which are not of interest are deleted or otherwise discarded. The cropped images containing only the objects of interest are then analyzed to identify and label the objects of interest within the cropped images, such as, but not limited to, the images.

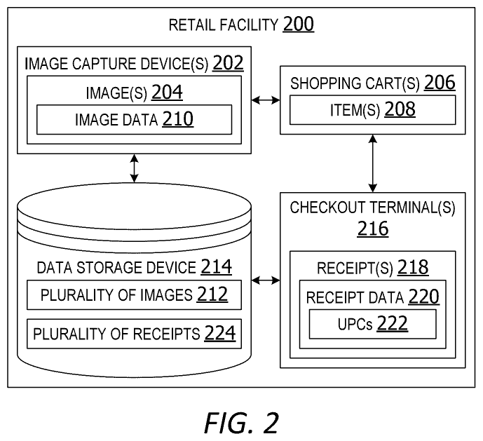

FIG. 2 is an exemplary block diagram illustrating a retail facility 200 including image capture devices and checkout terminals for generating receipts and cart images. The retail facility 200 is any type of brick-and-mortar facility, such as a retail store. One or more image capture device(s) 202 generating one or more image(s) 204 of one or more shopping cart(s) 206 containing one or more item(s) 208 being purchased or already purchased by one or more customers. The image capture device(s) 202, in some examples, include one or more digital cameras capturing digital images of the shopping cart(s) 206. The digital image(s) include image data 210. In this example, the image capture device(s) 202 include three cameras at or near the checkout terminal. However, the embodiments are not limited to three cameras. In other examples, the image capture device(s) 202 include a single camera, two cameras, as well as four or more cameras.

The plurality of images 212 generated by the image capture device(s) 202 are optionally stored on a data storage device 214. The plurality of images 212 include cart images, such as, but not limited to, the cart image(s) 122 in FIG. 1. The data storage device 214 is a device for storing data, such as, but not limited to, the data storage device 128 in FIG. 1. In other examples, the plurality of images 212 are stored on a cloud storage, such as, but not limited to, the cloud server 118 in FIG. 1.

One or more checkout terminal(s) 216 generate one or more receipt(s) 218 including receipt data 220 associated with the purchase of one or more item(s) 208 purchased by customers. The checkout terminal(s) 216 include any type of checkout terminal, such as, but not limited to, a staffed POS device, a self-checkout device, a Scan-N-Go (SNG) device, or any other type of checkout device. The checkout terminal(s) 216 enable a user to complete a purchase transaction for one or more items and receive a receipt documenting the purchase transaction. The receipt data includes information, such as, but not limited to, a store ID, a checkout terminal ID, a time of purchase, date of purchase, item ID for each item purchased, number of items purchased, name of items purchased, description of items purchased, and/or type of payment provided to complete the purchase. In some embodiments, the receipt data includes a UPC 222 or other item ID for each item purchased. The plurality of receipts 224 and/or the plurality of images 212 generated within a given time period are stored as historical data on the data storage device 214 located in the retail facility. In other embodiments, the plurality of receipts 224 and/or the plurality of images 212 are stored on a cloud storage or other remote data storage device which is accessed via a network, such as, but not limited to, the network 112 in FIG. 1.

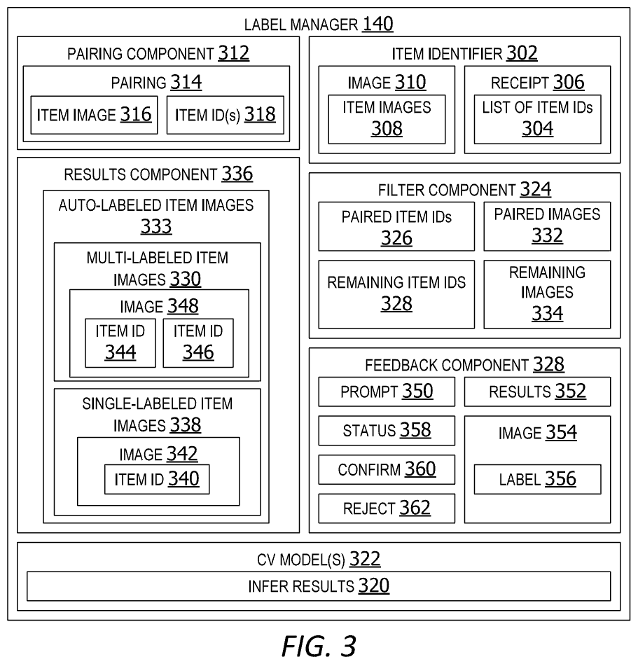

Referring now to FIG. 3, an exemplary block diagram illustrating a label manager 140 for automatically labeling images with dynamic filtering is shown. In some embodiments, an item identifier 302 identifies a list of item IDs 304 associated with a plurality of items purchased during a transaction and recorded in a receipt 306. The receipt 306 is a receipt such as, but not limited to, the receipt(s) 124 in FIG. 1 and/or the receipt(s) 218 in FIG. 2.

In other examples, the item identifier obtains a plurality of item images 308 cropped from a source image, such as a cart image 310. The cart image 310 is an image of a shopping cart containing one or more items associated with the receipt. Each item image in the plurality of item images 308 includes an image of a single item cropped from the cart image 310.

A pairing component 312 pairs or matches each item image in the plurality of item images 308 with one or more candidate item IDs in the extracted list of item IDs 304. The pairing component 312 creates a pairing 314 of an item image 316 from the cropped item images in the plurality of item images 308 with one or more item ID(s) 318 from the candidate IDs in the list of item IDs 304. In some embodiments, the item infer results 320 are obtained from one or more CV model(s) 322. A CV model is any type of deep learning model, such as, but not limited to, an object detection model, an object recognition model, a classification model, and/or a verification model. The CV model(s) generate a probable identification of the item in the cropped item image with a probability value indicating the likelihood that the predicted item ID selected from the list of item IDs is correct. If the probability is more likely than not (greater than fifty percent), the item ID is considered very likely, and the item image is paired with only that item ID. That paired item ID is filtered from the candidate item IDs in the list of item IDs obtained from the receipt. The filtering is performed by the filter component

In some embodiments, the filter component 324 filters paired item IDs 326 from a pool of candidate item IDs (list of item IDs) in real time as the pairing is being performed. Only item IDs which have a high probability of being correct (greater than 50%) are paired with a single image and filtered from the candidate pool. The paired images 332 which have been paired with a single item ID are also removed from a pool of unpaired item images. The remaining item IDs 328 after filtering are then paired with the remaining images 334. These remaining images 334 do not have a single item ID match which is most likely correct. Thus, these remaining item images are paired with one or more remaining item IDs and presented to a human user for verification as to which of the multiple paired item IDs is correct, if any.

A results component 336, in some embodiments, presents the results 352, including auto-labeled item images 333 to a user via a user interface, such as, but not limited to, the user interface device 110 and/or the UI device 120 in FIG. 1. The auto-labeled item images 333 include single-labeled item images 338 having a single item image 342 paired with a single item ID 340 and/or multi-labeled item images 330.

In some embodiments, the results 352 include the auto-labeled item images 333. The auto-labeled item images 333 optionally include multi-labeled item images 330 having a single item image 348 paired with two or more item IDs which are potential matches with the item image, such as, but not limited to, a first item ID 344 and a second item ID 346. In this example, a single item image is paired with two item IDs. However, the embodiments are not limited to matching two potential item IDs with the item image. In other examples, three or more item IDs from the list of item IDs (unfiltered candidate item IDs) are matched with the item image for review by a human user. The results 352 are optionally reviewed by a human user to verify accuracy of the labels automatically assigned to the images.

In some embodiments, the feedback component provides a prompt 350 to a user to obtain feedback from the user regarding the item image-to-item ID pairing results. Each item image 354 is presented with an automatically generated label 356 for review. The user updates a status 358 of the image 354 label 356. The label 356 includes the paired item ID(s). The user can optionally a confirm 360 message indicating the label is correct or reject 362 message indicating an incorrect label. The user in some examples corrects the label if the label is rejected/incorrect. The status 358 includes a correct status, an incorrect status, a new (unlabeled) status, and/or any other type of status for each item image.

In this example, the CV model(s) 322 are implemented as part of the label manager 140. However, in other examples, the CV model(s) are separate components from the label manager 140. In these examples, the label manager 140 obtains the infer results 320 from the CV models.

In this example, the CV models are implemented on a computing device, such as the computing device 102 in FIG. 1. However, in other embodiments, the CV model(s) 322 are implemented on a separate computing device from the computing device implementing the label manager 140 and/or on a cloud server, such as, but not limited to, the cloud server 118 in FIG. 1.

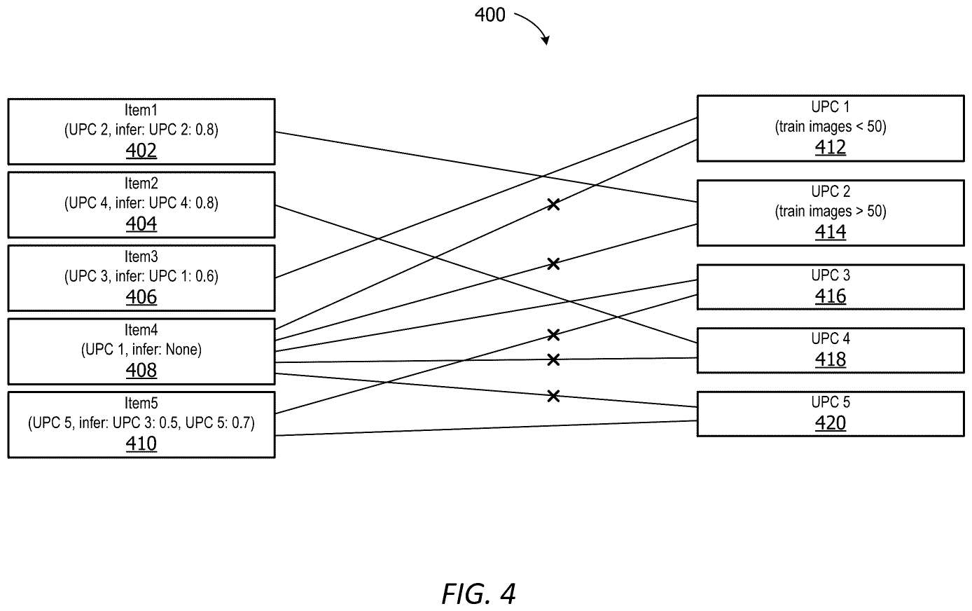

FIG. 4 is an exemplary block diagram illustrating pairing 400 item identifiers (IDs) with item images using dynamic filtering. In this example, a set of item images includes five item images. Each item image includes an image of a single item or portion of a single item cropped from an image of a shopping cart (cart image), such as, but not limited to, the item images for the items, such as the first item 402, 404, the second item 406, the fourth item 408, and/or fifth item 410.

A set of candidate item IDs includes five possible UPCs to be matched to the five item images, such as, but not limited to, the first UPC (UPC 1) 412, the second UPC (UPC 2) 414, the third UPC (UPC 3) 416, the fourth UPC (UPC 4) 418, and/or the fifth UPC (UPC 5) 420. The inferred (infer) results indicate that the item image for a first item 402 has an eighty percent (0.8) probability of matching the second UPC 414. This is the only infer result (match) for item one. Therefore, this is a one-to-one match. Item one is paired with the second UPC 414. The second UPC 414 is filtered from the set of candidate item IDs.

The inferred results for the second item 404 indicates an eighty percent (0.8) probability that the fourth UPC 418 is a match with the item image for item two. There is only a single match. Therefore, the second item (item 2) 404 is paired with the fourth UPC 418. UPC 418 is filtered from the pool of candidate item IDs.

The inferred results for the third item 406 indicates a sixty percent (0.6) probability that the image of item three should be identified as the first UPC 412. There is only a single inferred (infer) result that is greater than a fifty percent probability. Therefore, the third item is paired with the first UPC 412. The first UPC 412 is filtered from the candidate item IDs.

In this example, there are no inferred results for the fourth item 408. In this example, the CV model(s) fail to recognize the item in the image of item four. Therefore, item four is paired with all the remaining item IDs. In this example, the fourth item 408 is paired with both the third UPC 416 and the fifth UPC 420.

The fifth item 410, in this example, includes infer results for two different item UPCs. The third UPC 416 has a probability of fifty percent (0.5) and the fifth UPC 420 has a probability of seventy percent (0.7). In this example, the system is able to determine that the fifth UPC 420 is more likely the correct pairing. The fifth item 410 is paired with the fifth UPC 420. The fifth UPC 420 is filtered from the pool of candidate item IDs. Therefore, the pairing of the fourth item 408 is updated to eliminate the fifth UPC 420. This leaves the fourth item paired with only the third UPC 416. The results are presented to a human user for verification. In this manner, the system is able to label each item image more accurately and efficiently with fewer errors and minimal human intervention.

In this example, there are five item images and five item IDs. However, the embodiments are not limited to five item images and five item IDs. In other examples, the set of item images can include less than five images or more than five images. Likewise, the set of candidate item IDs can include less than five item IDs or more than five item IDs. Moreover, the number of candidate item IDs in the pool of candidate item IDs obtained from a receipt may not be equal to the number of item images cropped from a cart image corresponding to the receipt.

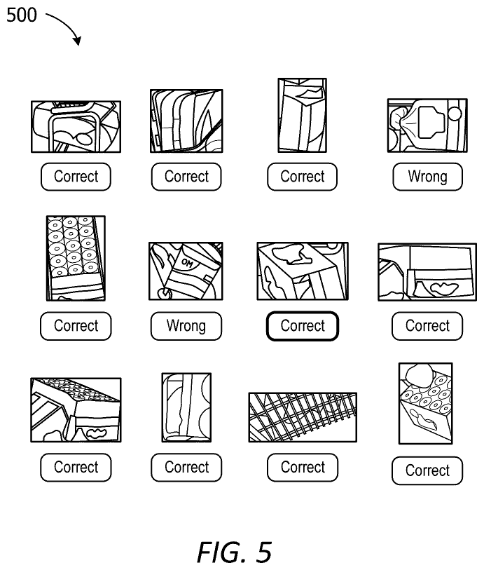

Turning now to FIG. 5, an exemplary block diagram illustrating status update of labeled images via a results user interface (UI) page 500 is shown. In this example, the auto-labeling review page displays cropped images of paper towel packages selected from transactions containing a selected item UPC associated with a paper towel product after the algorithm filtering. The page contains noisy item images. For example, there are some item images of products which are not paper towel packages included in the results for the selected item ID for paper towels. These noisy (negative) images inadvertently mixed with positive images of the paper towels. A user optionally reviews the labeled images and indicates whether the images are correct for images of the paper towels or incorrect for images which are not the selected paper towels item. Incorrect images are labeled as “wrong,” in this non-limiting example.

FIG. 6 is an exemplary flow diagram illustrating operation of the computing device to apply dynamic filtering during automatic labeling of item images. The process 600 shown in FIG. 6 is performed by a label manager component, executing on a computing device, such as the computing device 102 or the user device 116 in FIG. 1.

In a cart image frame 602 of a single transaction 604, a full list of receipt UPCs 606 is initiated with the goal of finding the corresponding item image for each of the receipt UPCs 620 in the cart image frame. After item detection and cropping is achieved, a list of item images 608 and infer results are obtained for each item image 610 generated by classification and verification model(s), respectively. If there are inferred result(s) at 612, the current item is assigned to the item IDs (UPCs) identified in the infer results 614 corresponding to receipt UPCs 616 as probably matches with the object in the item image. Those matched (paired) UPCs are filtered (removed) from the current frame receipt pool of candidate item IDs at 618. If there are no inferred results for the item image, remaining UPCs in the pool of candidate item IDs from the receipt are assigned to the current item image. The system iteratively processes all frames corresponding to the same receipt (same transaction) in a loop and applies the algorithm to all desired transactions. The system generates a UI page to allow one or more users to approve labeling, correct labeling and/or further label item images selected by the auto-labeling pipeline.

FIG. 7 an exemplary flow chart illustrating operation of the computing device to generate labeled item images at a single transaction level for use in training data. The process 700 shown in FIG. 7 is performed by a label manager component, executing on a computing device, such as the computing device 102 or the user device 116 in FIG. 1.

The process begins by identifying candidate item IDs from a receipt at 702. The receipt is a record of items purchased during a single transaction, such as, but not limited to, the receipt(s) 124 in FIG. 1, the receipt(s) 218 in FIG. 2, and/or the receipt 306 in FIG. 3. The label manager obtains cropped item images at 704. The cropped item images are images of individual items visible in a cart image corresponding to the receipt transaction. The label manager pairs matching item images with item IDs using infer results at 706. The label manager filters paired item IDs from the pool of candidate item IDs at 708. The label manager matches remaining item IDs with unlabeled item images at 710. The unlabeled item images are images for which infer results have no match or multiple matches. The results are presented to a user via a results page at 712. The results page, in some embodiments, is presented via a user interface, such as, but not limited to, the user interface device 110 and/or the UI device 120 in FIG. 1. The process terminates thereafter.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

FIG. 8 is an exemplary flow chart illustrating operation of the computing device to filtering paired item IDs from a pool of candidate item IDs during automatic labeling of item images. The process 800 shown in FIG. 8 is performed by a label manager component, executing on a computing device, such as the computing device 102 or the user device 116 in FIG. 1.

The process begins by extracting item IDs from a receipt at 802. Item images are obtained from a cart image at 804. The cart image is an image of a cart captured at or near a checkout terminal by an image capture device, such as, but not limited to, the image capture device(s) 202 in FIG. 2. Infer results are generated at 806. A determination is made whether a selected item ID is matched with an item image at 808 based on the infer results. If yes, the paired (matching) item ID is filtered from the candidate item IDs at 810. If not, the process terminates thereafter.

A determination is made whether a next item ID is matched to another item image based on the infer results at 812. If not, the process terminates thereafter. If a next item ID is matched at 812, the process iteratively repeats operations 808 through 812 until all paired item IDs are filtered from the candidate item IDs. The system determines if any item image remains unpaired with at least one item ID at 814. An item image remains unpaired if there are no inferred results matching the item image with a candidate item ID. If not, the process terminates. If an item image does remain unpaired with at least one item ID at 814, the remaining item IDs in the pool (set) of candidate item IDs are paired with each of the remaining unpaired item images at 816. The process terminates thereafter.

While the operations illustrated in FIG. 8 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 8.

FIG. 9 an exemplary flow chart illustrating operation of the computing device to verify labeled image data at a single transaction level with feedback obtained via a UI. The process 900 shown in FIG. 9 is performed by a label manager component, executing on a computing device, such as the computing device 102 or the user device 116 in FIG. 1.

The process begins by presenting pairing results to a user via a UI at 902. The user is prompted to provide feedback at 904. A determination is made whether feedback is received at 906. If not, the process terminates. If feedback is received, the item image labeling is updated based on the feedback at 908. The feedback can include confirmation of correct labeling, indication of incorrect labeling, correction of an incorrect label, and/or update of the status of a labeled item image. The process terminates thereafter.

While the operations illustrated in FIG. 9 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 9.

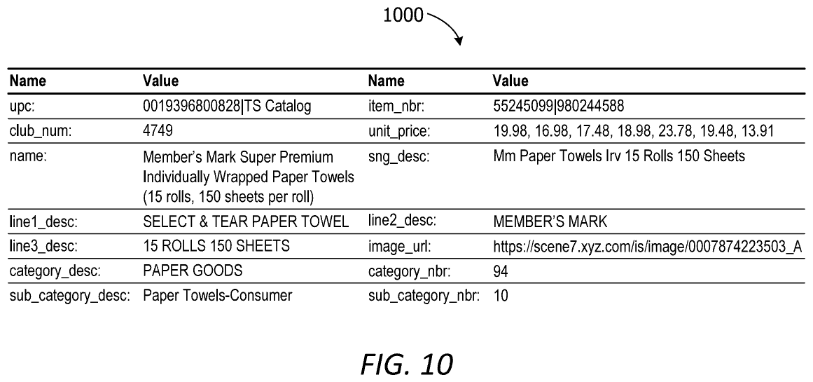

FIG. 10 is an exemplary table 1000 illustrating item data used during pairing of item images with item IDs. In this example, the table 1000 is displayed with auto-labeling results in a results UI page. In this example, the table 1000 includes catalog information associated with a selected item. The table is displayed followed by auto-labeling results of the selected item in a results UI page.

In this example, the item is paper towels. However, the examples are not limited to paper towels. The selected item can include any type of item. As it displays the results to the user, the catalog table info of “Member's Mark Paper Towels” optionally includes cropped item images of the paper towels.

### Additional Examples

In some embodiments, the system automatically pairs item images to item identifiers (UPCs) to generate labeled item images for use as training data instead of manual labeling. The system uses item identifiers from receipts and images of the items at the point-of-sale (POS). The results are output to a user via an auto-labeling UI page. A user verifies the results (feedback). The system minimized the manual effort required for labeling images and minimizes user time. Automatic labeling (auto-labeling) is a combination of algorithm selection and manual image labelling. The algorithm selection is code-based generation according to all transactions happening every single day. The manually labelled results are presented on a UI page.

In other embodiments, the system provides a process to label item images by generating a list of item UPCs from a receipt, generating a list of all item images from one or more cart images, and pairing the item images to the item UPCs. Receipt sampling is employed, and those receipts corresponding to UPCs with fewer templates have a higher chance of being sampled, in order to minimize redundancy. It may not be feasible to fully automate item image labeling, but this system enables minimizing manual effort by human users as much as possible. After auto-labeling, the labeled images are presented to the human users for verification and/or further labeling where the results eliminate erroneous matches while streamlining possible combinations of paired images and item UPCs requiring review.

Instead of assigning all receipt UPC to unmatched item images, the system filters matched UPCs and only matches unfiltered UPCs with the images. This enables human labelers to determine which UPCs should be matched with which unmatched cropped images, while minimizing the manual effort required from human labelers by using item infer results. The infer results can include a single recognition result (one match), no recognition result or multiple recognition results (possible matches). In one example, if an item UPC has an infer result probability of 70% recognition for an item image, the system assigns that result to the candidate item UPC. The paired item images and item IDs (UPCs) are output to a human labeler for verification and/or correction. This reduces both time expenditure by the human users as well as reducing system resource usage (processor and memory usage) consumed by the computing device during generation of the image labels.

Alternatively, or in addition to the other examples described herein, examples include any combination of the following:
filter the paired set of item images from the plurality of item images, wherein a set of remaining item images in the plurality of item images includes any remaining item images remaining unpaired with a single item ID after filtering;
add labeled image data to a set of training data images for use in training computer vision models;
receive a status update from the user via the UI device, the status update comprising a confirmation of a label or a rejection of a label;
generate, by a classification and verification model, an inference result for a selected item image in the plurality of item images;
match the selected item image with an item ID having a highest probability of corresponding to the selected item image based on the inference result;
present each item image with a filtered set of matching item IDs and a status of each item image in a results page via the UI device;
request feedback from the user confirming a correct item ID for labeling each item image;
generating item infer results for each item image in the plurality of item images by a classification and verification model;
pairing a first item image in the plurality of item images with a first item ID in the set of candidate item IDs based on the item infer results;
filtering the first item ID from the set of candidate item IDs;
pairing a second item image in the plurality of item images a set of item IDs remaining in the set of candidate item IDs after filtering the first item ID, the set of item IDs remaining in the set of candidate item IDs comprising a second item ID and a third item ID;
presenting the first item image paired with the first item ID and the second item image paired with the second item ID and the third item ID to a user via a user interface (UI) device for status review;
identifying a set of candidate item identifiers (IDs) associated with a plurality of items in a receipt associated with a selected transaction in a retail facility;
generating a plurality of item images from a cart image associated with the receipt, each item image in the plurality of item images comprising an image of a single item cropped from the cart image;
pairing a set of item images with a set of matching item IDs, wherein each item image is paired with a single item ID from the set of candidate item IDs using item recognition results obtained from an item recognition model to form a set of single-labeled item images;
filtering the set of matching item IDs from the set of candidate item IDs, wherein a set of remaining item IDs in the set of candidate item IDs includes any item IDs remaining unpaired with a single item image from the plurality of item images after filtering;
matching each item image in the set of remaining item images with each item ID in the set of remaining item IDs, wherein each item image in the set of remaining item images is paired with multiple item IDs to form a set of multi-labeled item images;
presenting the set of single-labeled item images and the set of multi-labeled (multiple labeled) item images to a user via a user interface (UI) device;
receiving a status update from the user via the UI device, the status update comprising a confirmation of a label or a rejection of a label;
obtaining a plurality of cart images corresponding to the receipt;
selecting a first cart image from the plurality of cart images;
generating a first set of single-labeled item images and a first set of multi-labeled item images for output to the user via the UI device for status review based on the first cart image;
selecting a second cart image from the plurality of cart images;
generating a second set of single-labeled item images and a second set of multi-labeled item images for output to the user via the UI device for status update based on the second cart image;
updating a status of an item image from an unlabeled status to a correctly labeled status;
updating a status of an item image from an unlabeled status to an incorrectly labeled status;
presenting a selected multi-labeled item image with at least two possible item IDs;
receiving feedback from the user identifying an item ID from the at least two possible item IDs;
matching the identified item ID with the selected multi-labeled item image;
assigning all remaining item IDs in the set of remaining item IDs to an item image responsive to a failure to match any item ID in the set of candidate item IDs with the item image;
assigning multiple item IDs in the set of remaining item IDs to an item image responsive to identifying the multiple item IDs as possible matches with the item image;
extract a set of candidate item identifiers (IDs) associated with a plurality of items from a receipt, the receipt corresponding to a selected transaction associated with a purchase of a plurality of items;
obtaining a plurality of item images from a cart image corresponding to the receipt, each item image in the plurality of item images comprising an image of a single item cropped from the cart image;
generating item infer results for each item image in the plurality of item images by a classification and verification model;
pairing a first item image in the plurality of item images with a first item ID in the set of candidate item IDs based on the item infer results;
filtering the first item ID from the set of candidate item IDs;
pairing a second item image in the plurality of item images a set of item IDs remaining in the set of candidate item IDs after filtering the first item ID, wherein the second item image is paired with a second item ID and a third item ID;
presenting the first item image paired with the first item ID and the second item image paired with the second item ID and the third item ID to a user via a user interface (UI) device for verification;
selecting the cart image from a plurality of cart images corresponding to the receipt, the selected cart image including a plurality of items associated with the selected transaction;
adding labeled image data to a set of training data images for use in training computer vision models;
training a CV model to recognize the plurality of items using the set of training data images;
filtering the set of candidate item IDs in real-time as each candidate item ID is paired with an item image;
assigning any remaining candidate item IDs to any remaining item images after filtering is completed;
presenting item images paired with at least one item ID to the user in a results page via the UI device;
prompting the user to update a status of each item image to confirm a correct item ID and reject any incorrect item ID paired with each item image; and
generate item image-to-item ID results for each cart image in a plurality of images corresponding to each receipt in a plurality of receipts associated with a plurality of transactions occurring within a user configurable retrieval time period.

At least a portion of the functionality of the various elements in FIG. 1, FIG. 2, FIG. 3, FIG. 4, and FIG. 5 can be performed by other elements in FIG. 1, FIG. 2, FIG. 3, FIG. 4, and FIG. 5, or an entity (e.g., processor 106, web service, server, application program, computing device, etc.) not shown in FIG. 1, FIG. 2, FIG. 3, FIG. 4, and FIG. 5.

In some examples, the operations illustrated in FIG. 6, FIG. 7, FIG. 8, and FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of dynamic filtering and selective item-to-image pairing for accurate auto-labeling image data, the method comprising identifying a set of candidate item IDs associated with a plurality of items in a receipt associated with a selected transaction in a retail facility; generating a plurality of item images from a cart image associated with the receipt, each item image in the plurality of item images comprising an image of a single item cropped from the cart image; pairing a set of item images with a set of matching item IDs, wherein each item image is paired with a single item ID from the set of candidate item IDs using item recognition results obtained from an item recognition model to form a set of single-labeled item images; filtering the set of matching item IDs from the set of candidate item IDs, wherein a set of remaining item IDs in the set of candidate item IDs includes any item IDs remaining unpaired with a single item image from the plurality of item images after filtering; matching each item image in the set of remaining item images with each item ID in the set of remaining item IDs, wherein each item image in the set of remaining item images is paired with multiple item IDs to form a set of multi-labeled item images; presenting the set of single-labeled item images and the set of multi-labeled item images to a user via a user interface (UI) device; and receiving a status update from the user via the UI device, the status update comprising a confirmation of a label or a rejection of a label.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for dynamic filtering and selective item-to-image pairing for accurate auto-labeling image data. For example, the elements illustrated in FIG. 6, FIG. 7, FIG. 8, and FIG. 9, such as when encoded to perform the operations illustrated in FIG. 1, FIG. 2, FIG. 3, FIG. 4, and FIG. 5, constitute exemplary means for extracting a set of candidate item identifiers (IDs) associated with a plurality of items from a receipt, the receipt corresponding to a selected transaction associated with a purchase of a plurality of items; exemplary means for obtaining a plurality of item images from a cart image corresponding to the receipt, each item image in the plurality of item images comprising an image of a single item cropped from the cart image; exemplary means for generating item infer results for each item image in the plurality of item images by a classification and verification model; exemplary means for pairing a first item image in the plurality of item images with a first item ID in the set of candidate item IDs based on the item infer results; exemplary means for filtering the first item ID from the set of candidate item IDs; exemplary means for pairing a second item image in the plurality of item images a set of item IDs remaining in the set of candidate item IDs after filtering the first item ID, wherein the second item image is paired with a second item ID and a third item ID; and exemplary means for presenting the first item image paired with the first item ID and the second item image paired with the second item ID and the third item ID to a user via a user interface (UI) device for verification.

Other non-limiting examples provide one or more computer storage devices having a first computer-executable instructions stored thereon for providing dynamic filtering and selective item-to-image pairing for accurate auto-labeling image data. When executed by a computer, the computer performs operations including extracting a set of candidate item identifiers (IDs) associated with a plurality of items from a receipt associated with a selected transaction in a retail facility; obtaining a plurality of item images from a cart image using an item detection model, each item image in the plurality of item images comprising an image of a single item cropped from the cart image; pairing a set of item images with a set of matching item IDs, wherein each item in the paired set of item images is paired with a single item ID from the set of candidate item IDs using item recognition results obtained from an item recognition model to form a set of single-labeled item images; filtering the set of matching item IDs from the set of candidate item IDs, wherein a set of remaining item IDs in the set of candidate item IDs includes any item IDs remaining unpaired with a single item image from the plurality of item images after filtering; matching each unpaired item image in the plurality of item images with each item ID in the set of remaining item IDs, wherein each item image in the set of remaining item images is paired with multiple item IDs to form a set of multi-labeled item images; and presenting the set of single-labeled item images and the set of multi-labeled item images to a user via a user interface (UI) device.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ ”only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than

“A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for accurate auto-labeling of image data, the system comprising:
a processor; and
a computer-readable medium storing instructions that are operative upon execution by the processor to:
extract a set of candidate item identifiers (IDs) associated with a plurality of items from a receipt;
obtain a plurality of item images from a source image using an item detection model, each item image in the plurality of item images comprising an image of a single item obtained from the source image;
generate a set of single-labeled item images in a plurality of auto-labeled item images, wherein each item in the set of single-labeled item images is paired with a single item ID from the set of candidate item IDs, wherein a set of remaining item images includes any images in the plurality of item images remaining unpaired with an item ID from the set of candidate item IDs, wherein a set of remaining item IDs in the set of candidate item IDs includes any item IDs remaining unpaired with a single item image from the plurality of item images after filtering;
pair each image in the set of remaining item images with each item ID in the set of remaining item IDs; and
generate a set of multi-labeled item images in the plurality of auto-labeled item images, wherein a multi-labeled item image is an item image from the set of remaining item images paired with each item ID within the set of remaining item IDs, wherein labeled training data is created using the plurality of auto-labeled item images.

2. The system of claim 1, wherein the instructions are further operative to:
present the set of single-labeled item images and the set of multi-labeled item images to a user via a user interface (UI) device; and
receive a status update from the user via the UI device, the status update comprising a confirmation of a label or a rejection of the label.

3. The system of claim 1, wherein the instructions are further operative to:
add labeled image data to a set of training data images for use in training computer vision models.

4. The system of claim 1, wherein the instructions are further operative to:
receive a status update via a user interface (UI) device, the status update comprising a confirmation of a label or a rejection of the label.

5. The system of claim 1, wherein the instructions are further operative to:
generate, by a classification and verification model, an inference result for a selected item image in the plurality of item images; and
match the selected item image with an item ID having a highest probability of corresponding to the selected item image based on the inference result.

6. The system of claim 1, wherein the instructions are further operative to:
present each item image with a filtered set of matching item IDs and a status of each item image in a results page via a user interface (UI) device; and
request feedback confirming a correct item ID for labeling each item image.

7. The system of claim 1, wherein the instructions are further operative to:
generate item infer results for each item image in the plurality of item images by a classification and verification model;
pair a first item image in the plurality of item images with a first item ID in the set of candidate item IDs based on the item infer results;
filter the first item ID from the set of candidate item IDs;
pair a second item image in the plurality of item images a set of item IDs remaining in the set of candidate item IDs after filtering the first item ID, the set of item IDs remaining in the set of candidate item IDs comprising a second item ID and a third item ID; and
present the first item image paired with the first item ID and the second item image paired with the second item ID and the third item ID to a user via a user interface (UI) device for status review.

8. A method for accurate auto-labeling image data, the method comprising:
identifying a set of candidate item identifiers (IDs) associated with a plurality of items in a receipt;
generating a plurality of item images from a source image associated with the receipt, each item image in the plurality of item images comprising an image of a single item removed from the source image;
pairing a set of item images with a set of matching item IDs, wherein each item image is paired with a single item ID from the set of candidate item IDs using item recognition results obtained from an item recognition model to form a set of single-labeled item images;
filtering the set of matching item IDs from the set of candidate item IDs, wherein a set of remaining item IDs in the set of candidate item IDs includes any item IDs remaining unpaired with a single item image from the plurality of item images after filtering;
matching each item image in a set of remaining item images with each item ID in the set of remaining item IDs, wherein each item image in the set of remaining item images is paired with multiple item IDs to form a set of multi-labeled item images;
presenting the set of single-labeled item images and the set of multi-labeled item images to a user via a user interface (UI) device; and
receiving a status update from the user via the UI device, the status update comprising a confirmation of a label or a rejection of the label.

9. The method of claim 8, further comprising:
obtaining a plurality of images corresponding to the receipt;
selecting a first image from the plurality of images;
generating a first set of single-labeled item images and a first set of multi-labeled item images for output to the user via the UI device for status review based on the first image;
selecting a second image from the plurality of images; and
generating a second set of single-labeled item images and a second set of multi-labeled item images for the output to the user via the UI device for the status update based on the second image.

10. The method of claim 8, further comprising:
updating a status of an item image from an unlabeled status to a correctly labeled status.

11. The method of claim 8, further comprising:
updating a status of an item image from an unlabeled status to an incorrectly labeled status.

12. The method of claim 8, further comprising:
presenting a selected multi-labeled item image with at least two possible item IDs;
receiving feedback from the user identifying an item ID from the at least two possible item IDs; and
matching the identified item ID with the selected multi-labeled item image.

13. The method of claim 8, further comprising:
assigning all remaining item IDs in the set of remaining item IDs to an item image responsive to a failure to match any item ID in the set of candidate item IDs with the item image.

14. The method of claim 8, further comprising:
assigning the multiple item IDs in the set of remaining item IDs to an item image responsive to identifying the multiple item IDs as possible matches with the item image.

15. One or more computer storage devices having computer-executable instructions stored thereon, which, upon execution by a computer, cause the computer to perform operations comprising:
identifying a set of candidate item identifiers (IDs) associated with a plurality of items in a receipt;
generating a plurality of item images from a source image associated with the receipt, each item image in the plurality of item images comprising an image of a single item removed from the source image;
pairing a set of item images with a set of matching item IDs, wherein each item image is paired with a single item ID from the set of candidate item IDs using item recognition results obtained from an item recognition model to form a set of single-labeled item images;
filtering the set of matching item IDs from the set of candidate item IDs, wherein a set of remaining item IDs in the set of candidate item IDs includes any item IDs remaining unpaired with a single item image from the plurality of item images after filtering;
matching each item image in a set of remaining item images with each item ID in the set of remaining item IDs, wherein each item image in the set of remaining item images is paired with multiple item IDs to form a set of multi-labeled item images; and
generating a set of auto-labeled item images comprising the set of multi-labeled item images and the set of single-labeled item images.

16. The one or more computer storage devices of claim 15, wherein the operations further comprise:
selecting the source image from a plurality of images corresponding to the receipt, the selected source image including the plurality of items.

17. The one or more computer storage devices of claim 15, wherein the operations further comprise:
adding labeled image data to a set of training data images for use in training computer vision models; and
training a CV model to recognize the plurality of items using the set of training data images.

18. The one or more computer storage devices of claim 15, wherein the operations further comprise:
filtering the set of candidate item IDs in real-time as each candidate item ID is paired with an item image; and
assigning any remaining candidate item IDs to any remaining item images after the filtering is completed.

19. The one or more computer storage devices of claim 15, wherein the operations further comprise:
presenting item images paired with at least one item ID to a user in a results page via a user interface (UI) device; and
prompting the user to update a status of each item image to confirm a correct item ID and reject any incorrect item ID paired with each item image.

20. The one or more computer storage devices of claim 15, wherein the operations further comprise:
generating item image-to-item ID results for each image in a plurality of images corresponding to each receipt in a plurality of receipts generated within a user configurable retrieval time period.
